(19) United States
(12) Patent Application Publication
(10) Pub. No.: US 2021/0268594 A1
(43) Pub. Date: Sep. 2, 2021

(54) DYNAMIC TORCH HEAD

(71) Applicant: The ESAB Group Inc., Florence, SC (US)

(72) Inventor: Michael Nadler, Wilmot, NH (US)

(21) Appl. No.: 17/178,357

(22) Filed: Feb. 18, 2021

Related U.S. Application Data
(60) Provisional application No. 62/982,153, filed on Feb. 27, 2020.

(51) Int. Cl. B23K 9/095; B23K 9/10

(52) U.S. Cl. CPC B23K 9/095; B23K 9/1012; B23K 9/1043

(57) ABSTRACT

A dynamic handheld torch head for a plasma cutting or welding operation is disclosed. The system for controlling the handheld torch includes a handle and a torch head disposed at the handle; a power supply; and a processor disposed at the power supply and/or the torch. The power supply may be configured to provide power to the torch to initiate a processing operation. The processor may be configured to determine an arc voltage between the torch head and a workpiece during the processing operation, and determine a distance between the torch head the workpiece based on the determined arc voltage.

### CROSS REFERENCE TO RELATED APPLICATIONS

This application claims priority to and is based on U.S. Provisional Application No. 62/982,153 filed on Feb. 27, 2020, entitled “Dynamic Torch Head,” the entire disclosure of which is incorporated herein by reference.

### FIELD OF INVENTION

The present invention relates to welding and cutting torches and, in particular, to handheld welding and cutting torches with a dynamic torch head.

### INTRODUCTION

In welding and plasma cutting, maintaining a constant distance between a bottom or distal end of a torch and a workpiece has an impact on quality of the weld or cut and the life of consumables in the torch. For example, in plasma cutting, when the distance between the bottom end of the torch and workpiece increases, the arc is stretched resulting in poor arc constriction (e.g. a “bushy” arc) and increased arc power. By comparison, when the distance between the bottom end of the torch and workpiece is lowered beyond a predetermined threshold, the tip can be damaged by slag and/or the arc can collide with an orifice defined by a consumable. In either case, the weld or cut quality and/or a life of consumables can decrease. Thus, maintaining a constant distance between the bottom or distal end of a torch and workpiece is desirable.

Highly skilled users have fine motor skills which help them maintain a constant distance between the bottom end of a torch and a workpiece, resulting in high weld or cut quality. But for unseasoned or infrequent users, a constant height can be difficult to maintain. In some instances, a drag tip or standoff attached to a torch head can be used to maintain a constant distance between the torch head tip and workpiece. Generally, a drag tip or a standoff serves as a guide by directly contacting the workpiece during a weld or cut operation. While a drag tip or standoff maintains a constant work height, friction between the workpiece and drag tip/standoff can cause cut/weld speed variations and, thus, can impact cut or weld quality. Moreover, drag tips or standoffs may not be desirable with non-planar or non-continuous workpieces, e.g., wire mesh or perforated sheets.

In view of at least the aforementioned issues, a handheld torch that can facilitate maintaining tip to workpiece distance is desirable.

### SUMMARY

The present disclosure relates to a system for controlling a handheld torch; a method of determining a distance between a torch head of a handheld torch and a workpiece; and a handheld torch assembly. In accordance with at least one embodiment of the present disclosure, the system includes a torch having a handle, a torch head disposed at the handle and a power supply having a processor. The power supply may be configured to provide power to the torch to initiate a processing operation, determine an arc voltage between the torch head and a workpiece during the processing operation, and determine a distance between the torch head the workpiece based on the determined arc voltage.

In accordance with at least one embodiment of the present disclosure, the system includes a torch having a handle, a torch head disposed at the handle and a power supply having a processor. The power supply may be configured to provide power to the torch to initiate a processing operation, determine an arc voltage between the torch head and a workpiece during the processing operation, and determine a distance between the torch head the workpiece based on the determined arc voltage. An actuator may be operatively coupled to the torch head and the handle, the actuator may be configured to move the torch head relative to the handle.

In accordance with at least one embodiment of the present disclosure, the system includes a torch having a handle, a torch head disposed at the handle and a power supply having a processor. The power supply may be configured to provide power to the torch to initiate a processing operation, determine an arc voltage between the torch head and a workpiece during the processing operation, and determine a distance between the torch head and the workpiece based on the determined arc voltage. An actuator may be operatively coupled to the torch head and the handle, the actuator may be configured to move the torch head relative to the handle. The power supply may be further configured to transmit a control signal to the actuator, the control signal being based on the determined distance between the torch head and the workpiece.

In accordance with at least one embodiment of the present disclosure, the system includes a torch having a handle, a torch head disposed at the handle and a power supply having a processor. The power supply may be configured to provide power to the torch to initiate a processing operation, determine an arc voltage between the torch head and a workpiece during the processing operation, and determine a distance between the torch head and the workpiece based on the determined arc voltage. An actuator may be operatively coupled to the torch head and the handle, the actuator may be configured to move the torch head relative to the handle. The power supply may be further configured to transmit a control signal to the actuator, the control signal being based on the determined distance between the torch head and the workpiece. In some implementations, the actuator moves the torch head relative to the handle based on the control signal. In some implementations, the power supply may be further configured to vary the control signal to maintain a predetermined distance between the torch head and the workpiece. In some implementations, the power supply may be further configured to stop transmitting the control signal in response to the arc voltage meeting a predetermined voltage.

In accordance with at least one embodiment of the present disclosure, the method for determining a distance between a torch head of a handheld torch and a workpiece includes measuring, by a processor, an arc voltage of an arc between the torch head and the workpiece; and determining, by the processor, a distance between the torch head and the workpiece based on the arc voltage. The processor may be disposed at the torch assembly or power supply.

In accordance with at least one embodiment of the present disclosure, the method for determining a distance between a torch head of a handheld torch and a workpiece includes measuring, by a processor, an arc voltage of an arc between the torch head and the workpiece; and determining, by the processor, a distance between the torch head and the workpiece based on the arc voltage. In some implementations, the processor may be disposed at the torch assembly or power supply. In some implementations, the determination may further include comparing the arc voltage to a criteria. In some implementations, the criteria may be a predetermined arc voltage.

In accordance with at least one embodiment of the present disclosure, the method for determining a distance between a torch head of a handheld torch and a workpiece includes measuring, by a processor, an arc voltage of an arc between the torch head and the workpiece; and determining, by the processor, a distance between the torch head and the workpiece based on the arc voltage. In response to the arc voltage varying from the criteria (e.g., a variance in the arc voltage), the method may further include causing an actuator in the handheld torch to adjust the distance between the torch head and the workpiece, wherein the distance may be adjusted proportionally to an amount the arc voltage varies from the criteria.

In accordance with at least one embodiment of the present disclosure, the method for determining a distance between a torch head of a handheld torch and a workpiece includes measuring, by a processor, an arc voltage of an arc between the torch head and the workpiece; and determining, by the processor, a distance between the torch head and the workpiece based on the arc voltage. The method further includes causing an adjustment of the torch head relative to the handle based on the measured arc voltage. In some implementations, the adjustment maintains a predetermined distance between the torch head and workpiece. In some implementations, the adjustment of the torch head comprises activating an actuator. In some implementations, the actuator may be one of, or any combination of, a coil actuator, electric drive motor, pneumatic drive motor, or shape-memory alloy actuator.

In accordance with at least one embodiment of the present disclosure, a handheld torch includes a torch having a handle that extends from a proximal end to a distal end, a torch head disposed at the distal end of the handle; and an actuator operatively coupled to the torch head and the handle, the actuator configured to move the torch head relative to the handle.

In accordance with at least one embodiment of the present disclosure, a handheld torch includes a torch having a handle that extends from a proximal end to a distal end, a torch head disposed at the distal end of the handle; and an actuator operatively coupled to the torch head and the handle, the actuator configured to move the torch head relative to the handle. In some implementations, the actuator may be further configured to move the torch head relative to the handle based on an arc voltage. In some implementations, the actuator may be further configured to receive a control signal from a power supply, and the actuator moves the torch head relative to the handle based on the control signal. In some implementations, the control signal may be based on an arc voltage.

In accordance with one or more embodiments of the present disclosure, a handheld torch may dynamically adjust its torch head tip to maintain a distance between the tip and a workpiece during a processing operation. By maintaining the distance between the tip and the workpiece, the quality of the processing operation (e.g., cut or weld) my increase and life of consumables may be extended.

### BRIEF DESCRIPTION OF THE DRAWINGS

To complete the description and in order to provide for a better understanding of the present invention, a set of drawings is provided. The drawings form an integral part of the description and illustrate an embodiment of the present invention, which should not be interpreted as restricting the scope of the invention, but just as an example of how the invention can be carried out. The drawings comprise the following figures:

FIG. 1A is a perspective view of a torch, power supply, and gas supply, according to an exemplary embodiment of the present invention.

FIG. 1B is a diagram illustrating a power supply with two separate power sources, according to an exemplary embodiment of the present invention.

FIGS. 2A-2D are diagrams illustrating a dynamic torch disposed at different distances from a workpiece, according to an exemplary embodiment of the present invention.

FIGS. 2E and 2F are diagrams illustrating head configurations of the dynamic torch, according to one or more exemplary embodiments of the present invention.

FIGS. 3 and 4 are flow diagrams of methods for controlling a torch head, according to an exemplary embodiment of the present invention.

FIG. 5 is a block diagram of an example controller formed in accordance with an exemplary embodiment of the present invention.

### DETAILED DESCRIPTION

The following description is not to be taken in a limiting sense but is given solely for the purpose of describing the broad principles of the invention. Embodiments of the invention will be described by way of example, with reference to the above-mentioned drawings showing elements and results according to the present invention.

Generally, the handheld torch system presented herein relates to determining a distance between a torch head of a handheld torch and a workpiece during a processing operation. The distance can be determined based on a voltage of an electrical arc between the torch head and workpiece. To generate this electrical arc, a power supply may provide an electrical current to the handheld torch for performing a processing operation. For example, the processing operation may be a plasma cutting operation or a welding operation, and the electric current may be supplied by the power supply at a constant current or amperage. The power supply may also supply one or more gases to the torch.

During the processing operation, the torch head of the handheld torch may be placed in close proximity to the workpiece for processing. Electrical current may be supplied to the torch head and, when the torch is in close proximity with a workpiece, the electrical current arcs across a gap between the torch head and the workpiece. The arc may travel across the gap through gas discharged from the torch head onto the workpiece (e.g., gas supplied by the power supply). In a plasma cutting operation, the arc and gas may cause portions of the workpiece to be cut away. For example, the arc and gas may generate a plasma stream that melts a portion of the workpiece. In a welding operation, the arc may melt a fill material and a workpiece to create a melt pool. As the arc moves from the melt pool, the pool cools and solidifies thereby creating a solid weld comprising the fill material and/or the workpiece material.

Maintaining a constant distance between the torch head and the workpiece during the processing operation may be desirable for performing a high-quality cut or weld. For example, a distance of about 0.19 inches between a distal end of a torch and a workpiece may be desirable for a plasma cutting operation, insofar as “about” indicates a range of plus or minus 0.05 inches, 0.02 inches, 0.01 inches, or any other range at or under 0.10 inches. While a skilled user who routinely performs the same processing operation may be able to maintain a constant distance between the torch head and workpiece, a user who does not routinely perform such operations may not be able to maintain the constant distance. This may impact the quality of the cut or weld. For example, during a processing operation, when a distance between the torch head and the workpiece is below a predetermined threshold, splatter of melted material may damage consumables (e.g., a tip, drag cap, electrode, fill material, etc.) of the torch and/or the torch itself. Additionally, or alternatively, the melted workpiece may cool while the torch tip or other consumable may be touching the workpiece, thus joining the workpiece with the torch tip or other consumable. If a consumable is joined to the workpiece, removing the torch tip or other consumable from the workpiece may damage the tip or other consumable and/or workpiece. Additionally, or alternatively, during a processing operation, when a distance between the torch head and the workpiece is above a predetermined threshold, a consumable (e.g., an electrode, torch tip, fill material, etc.) of the torch head may be damaged and/or experience excess wear.

As a torch head of a handheld torch moves closer to or further from a workpiece during the processing operation, the voltage of the arc may vary. For example, the voltage of the arc decreases as the torch head move closer to the workpiece. Alternatively, the voltage of the arc increases as the torch head moves away from workpiece. The techniques presented herein provide a processor disposed in the power supply and/or torch that may detect this voltage during the processing operation. Based on the detected voltage, the processor may determine a gap distance between the torch head and the workpiece. For example, the detected or measured voltage may be compared to a set of reference voltages that correspond to gap distances. Based on the comparison, the gap distance may be determined. Alternatively or additionally, the processor may calculate the gap distance by processing a measured arc voltage with an algorithm.

In an embodiment, a handheld torch having a dynamic torch head includes a handle, a torch head, and an actuator operatively coupled to the torch head and the handle. The actuator may be configured to move the torch head relative to the handle. The handheld torch may be configured to receive a current and process gas. During a processing operation, the current arcs between the torch head and workpiece. The actuator may be further configured to receive a signal indicative of a voltage of the constant current and/or arc. Based on the received signal, the actuator may move the torch head toward or away from the workpiece, or not move the torch head. For example, if the voltage is above a first threshold, the actuator may move the torch head towards the workpiece. Then, when the voltage is below a second threshold, the actuator may move the torch head away from the workpiece. The actuator may maintain the amount the torch head is displaced when the voltage is between the first and second thresholds.

In some implementations, the amount the torch head may be displaced by the actuator may be proportional to the voltage. As a further example, the speed at which the actuator displaces the torch head may be proportional to the voltage and/or a difference between the voltage and the first or second threshold. Accordingly, the actuator may maintain a constant or nearly constant distance between the torch head and workpiece, providing a high-quality cut or weld. Thus, the techniques presented herein may extend a life of consumable of the torch head (e.g., electrode, torch tip, shield cup, and/or gas distributor) as compared to consumables utilized in a handheld torch without a dynamic torch head.

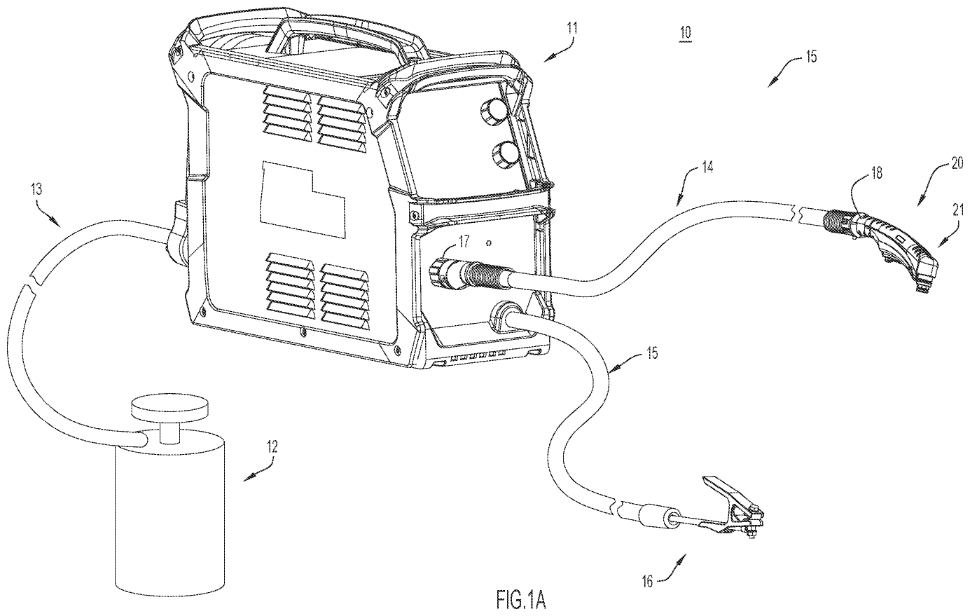

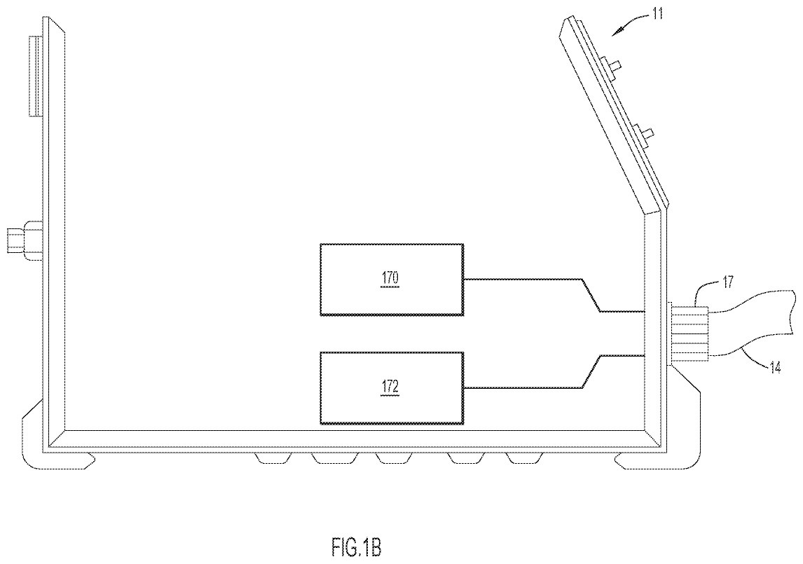

Various implementations of a dynamic torch head are disclosed herein. FIG. 1 illustrates an exemplary embodiment of a processing system for controlling a handheld torch 20 with dynamic torch head 21. The handheld torch 20 may be a handheld welding torch or a handheld plasma cutting torch. The depicted system 10 includes a power supply 11 that supplies power to a torch assembly 20. For example, the power supply 11 provides an electrical current at a predetermined voltage for generating an arc between the torch head 21 and a workpiece. The power supply 11 may also control the flow of a process gas from a process gas supply 12 to the torch assembly 20 (however, in other implementations, the power supply 11 may supply the process gas itself). The process gas supply 12 may be connected to the power supply via cable hose 13 and the power supply 11 may be connected to the torch assembly 20 via cable hose 14. The system 10 also includes a working lead 15 with a grounding clamp 16 disposed at an end thereof.

Cable hose 13, cable hose 14, and/or working lead 15 may each include various conductors that may transmit data, electricity, signals, etc. between components of the processing system 10 (e.g., between the power supply 11 and the torch assembly 20) and, as is illustrated, cable hose 13, cable hose 14, and/or working lead 15 may each be any length. In order to connect the aforementioned components of the cutting system 10, the opposing ends of cable hose 13, cable hose 14, and/or working lead 15 may each be coupled to the gas supply 12, power supply 11, torch assembly 20, or clamp 16 in any manner now known or developed hereafter (e.g., a releasable connection). The cable hose 14 may include a first connector 17 that releasably couples a first end of the cable hose 14 to a port of the power supply 11 and may also include a second connector 18 that releasably couples a second end of the cable hose 14 to the torch 20. Thus, the torch 20 may be releasably coupled to the power supply 11 via a releasable connection formed between the cable hose 14 and the power supply 11 and/or via a releasable connection formed between the cable hose 14 and the torch 20.

According to some implementations, power may be supplied to the torch head 21 and an actuator included in the torch 20 by separate power sources. For example, as shown in FIG. 1B the power supply 11 may include a first power source 170 configured to deliver AC or DC power of a first voltage to the torch head 21 through a first conductor extending through the cable hose 14, and a second power source 172 configured to deliver DC power at a second voltage less than the first voltage to the actuator through a second conductor also extending through the cable hose 14. However, this is just one example and in other embodiments, an actuator in the torch 20 can be powered in any manner, including by power delivered to the torch head to power a processing operation (e.g., cutting or welding power).

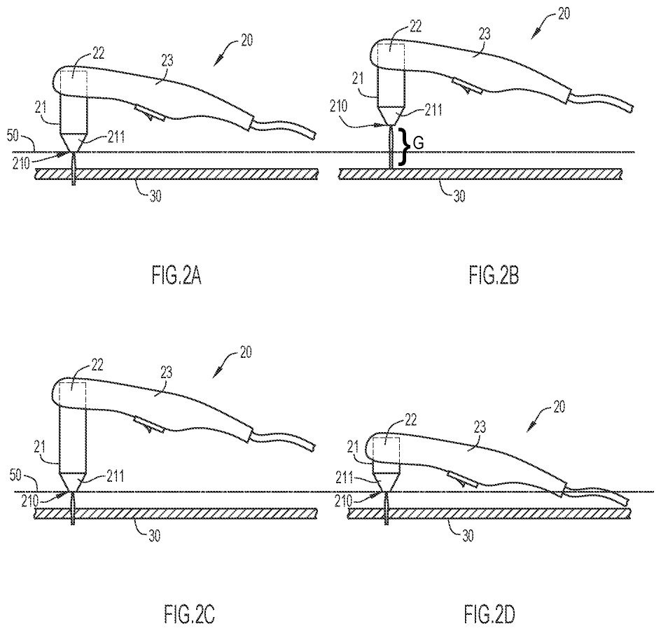

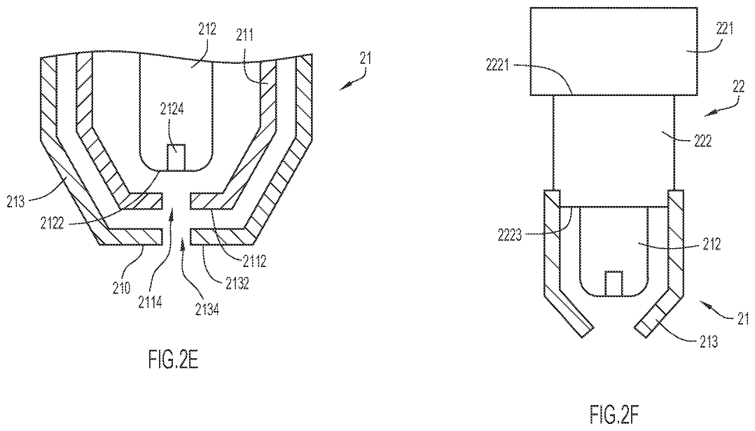

Referring to FIGS. 2A-2D, the handheld torch assembly 20 is illustrated at different heights during a processing operation. During the processing operation, a processor (not shown) disposed in the torch assembly 20 and/or power supply 11 detects, monitors, and/or measures a voltage of an arc between the torch head 21 and a workpiece. Based on the voltage of the arc, the processor determines a distance of a gap “G” between a distal end 210 of the torch head 21 and the workpiece 30 (See FIG. 2B), insofar as the term “torch head” is used herein to refer to the operative end of the torch 20 and/or a stack of consumables included on the operative end of torch 20. The processor transmits a signal to an actuator 22 to maintain a predetermined distance 50 between the distal end 210 of the torch head 21 and the workpiece 30.

FIGS. 2A-2D depict an example dynamic torch 20 operating on a workpiece 30 while the techniques presented herein maintain a bottom or distal end 210 (see FIG. 2B) of the torch assembly 20, which is defined by a bottom of tip 211 in the embodiment depicted in FIGS. 2A-2D, at a predetermined distance 50 from the workpiece 30. In FIG. 2A, the torch assembly 20 is being maintained at a predetermined, or desired, distance 50 from the workpiece 30 and, thus, the actuator 22 is not moving the torch head 21. In FIG. 2B, the distance between the torch assembly 20 and the workpiece is shown as being greater than the desired distance 50. In response, the processor sends a signal to the actuator 22 to cause the torch head 21 to translate (e.g. extend) relative to the torch handle 23 in order to maintain the desired, or predetermined, distance 50 between the distal end 210 of the torch head 21 and workpiece 30.

FIG. 2C shows the torch head 21 extended to maintain the predetermined distance 50. By comparison FIG. 2D shows the torch head 21 retracted, translated upwards, or otherwise moved away from workpiece 30 to maintain the predetermined distance 50. As one example, in FIG. 2D, the torch head 21 may have been retracted when the distance between the torch assembly 20 and the workpiece was determined to be less than the desired distance. In response, the processor sends a signal to the actuator 22 to cause the torch head 21 to translate (e.g. retract) relative to the torch handle 23 in order to maintain the predetermined distance 50 between the distal end 210 of the torch head 21 and workpiece 30.

Additionally, or alternatively, the processor may be configured to vary the signal to cause the actuator 22 to maintain the predetermined distance. For example, the signal may be based on the measured gap distance. Accordingly, the signal causes the actuator 22 to translate the torch head 21 by an amount proportional to the amount of deviation between the measured gap distance and the desired the gap distance. In some implementations, the speed at which the actuator 22 translates the torch head may also vary based on the signal. For example, the signal may include an instruction to the actuator 22 to accelerate translation of the torch head 21 based on the amount of deviation between the measured gap distance G and the desired the gap distance 50. As the measured gap distance G of the distal end 210 of the torch head 21 gets closer to the desired gap distance, the processor may adjust the signal to the actuator 22, thereby decelerating the translation of the torch head 21. In some implementations, the dynamic acceleration of the torch head 21 avoids overshooting the desired distance.

Although FIGS. 2A-2D illustrate a torch 20 with a tip 211 that defines the distal end 210 of the torch, this is just one example embodiment and in other embodiments, other components of the torch, such as consumable components may define the distal end 210. For example, FIG. 2E illustrates a torch head 21 assembly having at least an electrode 212 and a tip 211 (also referred to as a nozzle 211). The electrode includes an emissive insert 2124 disposed in a distal end 2122 of the electrode 212. The torch tip 211 includes a torch tip distal end 2112 with an orifice 2114 disposed therein. The orifice 2114 may be coaxial with the electrode 212 and emissive insert 2124. For example, the orifice 2114 may be aligned with the electrode 212 so that an arc may travel from the emissive insert 2124 at the distal end 2112 of the electrode 212 through the orifice 2114 of the torch tip 211 to a workpiece 30.

In some implementations, the torch head 21 may further include a shield 213 having an orifice 2134 at a distal end 2132 of the shield 213. The orifice 2134 of the shield 213 may be coaxial with the orifice 2114 of the torch tip 211. For example, the orifice 2134 of the shield 213 may be aligned with the orifice 2114 of the torch tip 211 and the electrode 212 so that an arc may travel from the emissive insert 2124 at the distal end 2112 of the electrode through the orifice 2114 of the torch tip 211 and the orifice 2134 of the shield 213 to a workpiece 30.

Generally, the measured distance G and predetermined gap distance may be measured from the distal end 210 of the torch to the workpiece 30. However, as mentioned, the distal end 210 may be defined by various portions of the torch 20. For example, in some implementations the distal end 210 of the torch 20 may be defined by the distal end 2112 of torch tip 211. As another example, in some implementations, the distal end 210 of the torch 20 may be defined by the distal end 2132 of the torch shield 213. As yet another example, in some implementations, the distal end 210 of the torch 20 may be defined by the distal end 2122 of the electrode 212. Thus, the gap distance G may be measured between the distal end 2112 of the torch tip 211 and the workpiece 30, the distal end 2132 of the shield 213 and the workpiece 30, and/or the distal end 2122 of the electrode 212 and the workpiece 30.

FIG. 2F illustrates an example embodiment of an actuator 22 that may be included in a dynamic torch presented herein. In this embodiment, the torch head includes an actuator 22 having a telescoping body. For example, the telescoping body may have a first body 221 having a distal end 2221 and a second body 222 having a distal end 2223. A torch head 21 may be disposed at the distal end 2223 of the second telescoping body 222. The torch head 21 may include an electrode 212 and torch tip 211. The torch tip 211 may circumferentially surround the electrode 212. In some implementations, the torch head 21 may further include a shield 213 (not shown) disposed at the distal end 2223 of the second telescoping body 222, circumferentially surrounding the torch tip 211 (not shown).

In the depicted embodiment, the actuator 22 may extend or retract the torch head 21 by translating the telescoping bodies 221 and 222. For example, to extend the torch head 21, the actuator may cause the distal end 2223 of the second body 222 to translate away from the distal end 2221 of the first telescoping body 221. To retract the torch head 21, for example, the actuator 22 may cause the distal end 2223 of the second body 222 to translate toward the distal end 2221 of the first telescoping body 221. That is, the second body 222 extends from and/or retracts into the first body 221 to translate the torch head 21. While only two telescoping bodies 221 and 222 are shown, the disclosure is not limited thereto. The telescoping body may include multiple bodies. For example, the telescoping body may include three or more bodies. However, in other embodiments, the actuator 22 need not be telescoping and can translate (e.g., extend and retract) in any way now known or developed hereafter.

Regardless of how the actuator causes a translation of the torch head 21, the actuator 22 may include an electric or pneumatic drive motor, a shape-memory alloy actuator, or any other type of actuator configured to cause translation of the torch head 21. For example, an electric drive motor may be an electromagnetic linear actuator, comprising a coil and magnet, the magnet disposed in the coil and attached to a plunger or directly to the torch head. When the coil is energized, the magnet moves along the coil. The direction the magnet moves through the coil corresponds to a direction of flow of current through the coils.

In some implementations the electric drive motor may include a screw actuator. A motor may cause a screw to rotate. Threads of the screw may engage threads of a nut of the actuator. The torch head may be coupled to the nut and move with the nut along the screw as the screw rotates. Alternatively, the nut may be fixed in the torch body and torch head may be coupled to an end of the screw. The torch head may translate with the screw as the screw and/or the nut rotates. The screw actuator may include a plurality of nuts and screws to actuate the torch head.

In some implementations, the electric drive motor may be a rack and pinion arrangement. The pinion may be connected to an electric motor. Teeth of the pinion engage grooves of a rack. As the pinion rotates, the rack translates along a tangent of the pinion. The torch head may translate with the rack. The rack and pinion arrangement may include a plurality of racks and pinions.

In some implementations, the pneumatic drive motor may include a pneumatic cylinder comprising a plunger and a valve, the valve disposed at a proximal end of the cylinder. A push rod connected to the plunger may be coupled to the torch head. Alternatively, the torch head may be coupled directly to the plunger. The torch head may translate in response to translation of the plunger.

In some implementations, the cylinder of the pneumatic drive motor may include a valve for regulating pressurized gas into the cylinder. The pressurized gas may cause the plunger to move in a first direction towards a distal end of the cylinder. A spring disposed between plunger and the distal end of the cylinder may compress in response to the plunger moving in the first direction. The valve may release the pressurized gas and the compressed spring may cause the plunger to return to its initial position.

In some implementations, the cylinder of the pneumatic drive motor may include a first port disposed at a proximal end of the cylinder and a second port disposed at a distal end of the cylinder. A plunger may be disposed in the cylinder and configured to translate between the first and second ports. A plurality of valves may be fluidly connected to a gas supply and a vent port, the plurality of valves may be configured to direct a flow of gas to the first port and fluidly connect the second port to a vent port. The plurality of valves may be further configured to direct a flow of gas to the second port and fluidly connect the first port to a vent port. The flow of pressurized gas to the first or second port may cause the plunger to translate towards the second or first port, respectively.

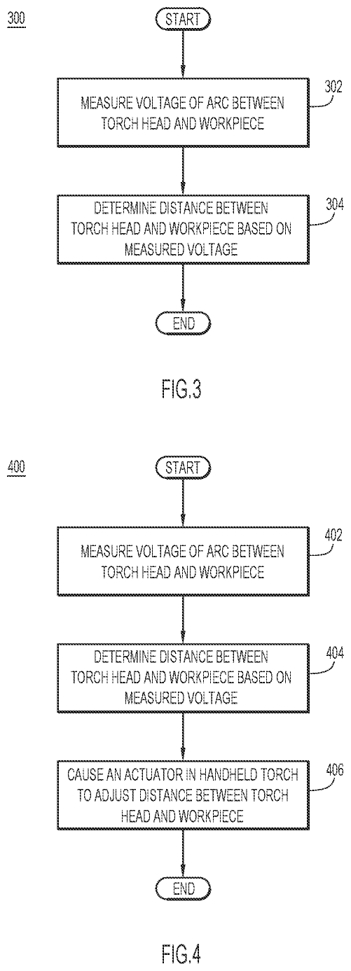

Referring to FIG. 3, an embodiment of a method 300 for determining a distance between a torch head of a handheld torch and a workpiece is shown. The handheld torch of method 300 may correspond to the handheld torch 20 discussed above with reference to FIGS. 1A-2F. The method 300 includes measuring an arc voltage of an arc between a distal end 210 of a torch head 21 and a workpiece 30 in operation 302 and determining a distance G between the distal end 210 of the torch head 21 and the workpiece 30 based on the arc voltage in operation 304.

In operation 302, an arc voltage of an arc between the distal end 210 of the torch head 21 and the workpiece 30 may be monitored or measured. During a processing operation, a power supply provides a processing current for a torch at a constant current. For example, the power supply may vary a voltage of the processing current to maintain the constant current. The supplied voltage may be indicative of an arc voltage between the distal end 210 of the torch head 21 and workpiece 30. As discussed above with reference to FIGS. 2A-2F, the distal end 210 of the torch head 21 may be a distal end 2122 of an electrode 212, a distal end 2112 of a tip 211, or a distal end 2132 of a shield 213. In some implementations, the voltage varied by the power supply may be the arc voltage. The power supply may monitor or measure the supplied voltage. In some implementations, the torch head may include a sensor to monitor or measure the supplied voltage.

In operation 304, the supplied voltage may be compared to a criteria. For example, the criteria may be a table of predetermined voltages and corresponding gap distances between a distal end of a torch head and a workpiece. Accordingly, the measured voltage may be compared to the table and a corresponding gap distance G may be extrapolated from the table. Alternatively, or in addition to, the criteria may be a threshold voltage. A difference between the threshold voltage and measured voltage may be determined. Based on the determined difference between the threshold voltage and measured voltage, a gap distance G may be calculated using an algorithm.

In some implementations the method 300 may include repeating operations 302 and 304 during a processing operation. The processing operation may be a plasma cutting operation or welding operation. During a plasma cutting operation, the arc may flow from a distal end of the torch head to the workpiece. During a welding operation, the arc may travel from a filler material (e.g., weld wire, weld strip, or other filler material capable of forming a weld), or an electrode, to the workpiece. The determined distance may be indicative of a gap distance G between the distal end of the filler material (often referred to in welding as a hot electrode) and the workpiece. As discussed above, the distal end of the torch head may be a distal end 2122 of an electrode 212, a distal end 2112 of a tip 211, or a distal end 2132 of a shield 213. In some implementations, for example welding operations, the gap distance G may be measured from distal end of filler material, e.g., a weld wire or weld strip.

Referring to FIG. 4, an embodiment of a method 400 for determining and controlling a distance between a torch head of a handheld torch and a workpiece is shown.

The handheld torch of method 400 may correspond to the handheld torch 20 discussed above with reference to FIGS. 1A-2C. The method 400 includes measuring an arc voltage of an arc between a distal end of a torch head and a workpiece in operation 402, determining a distance between the distal end of the torch head and the workpiece based on the arc voltage in operation 404, and causing an actuator in the handheld torch to adjust a distance between the distal end of the torch head and the workpiece in operation 406.

In operation 402, an arc voltage of an arc between the distal end of torch head and the workpiece may be monitored or measured. During a processing operation, a power supply provides a processing current for a torch at a constant current or amperage. For example, the power supply may vary a voltage of the processing current to maintain the constant current. The supplied voltage may be indicative of an arc voltage between the distal end of the torch head and workpiece. As discussed above, the distal end of the torch head may be a distal end 2122 of an electrode 212, a distal end 2112 of a tip 211, or a distal end 2132 of a shield 213. In some implementations, the voltage varied by the power supply may be the arc voltage. The power supply may monitor or measure the supplied voltage. In some implementations, the torch head may include a sensor to monitor or measure the supplied voltage.

In operation 404, the supplied voltage may be compared to a criteria. For example, the criteria may be a table of predetermined voltages and corresponding to gap distances between a distal end of a torch head and a workpiece. Accordingly, the measured voltage may be compared to the table and a corresponding gap distance G may be extrapolated from the table. Alternatively, or in addition to, the criteria may be a threshold voltage. A difference between the threshold voltage and measured voltage may be determined. Based on the determined difference between the threshold voltage and measured voltage, a gap distance G may be calculated using an algorithm. For example, the algorithm may be based on workpiece thickness, cut speed, and arc voltage.

In operation 406, actuator in the handheld torch may be activated to adjust the distance between the torch head and the workpiece. The actuator may move or displace the torch head relative to the handheld torch handle or body based on the measured voltage. In some implementations, the actuator may move the torch head proportionally to an amount the measured voltage varies from the criteria. For example, an arc voltage varies nearly linearly with variations in the distance between the workpiece and torch head. In other words, based on the measured voltage, the actuator extends or retracts the torch head to maintain a predetermined distance between a distal end of the torch head, or distal end of a consumable at the torch head, and a workpiece. For example, the measured voltage may be repeatedly or continuously monitored or updated. When the measured voltage is above the criteria, the actuator extends the torch head until the measured voltage meets the criteria, e.g., predetermined or threshold voltage. When the measured voltage is below the criteria, the actuator retracts the torch head until a voltage meets the criteria.

In some implementations, the actuator may be controlled based on the determined distance between the distal end of torch head (or consumable) and the workpiece. For example, the determined distance may be repeatedly or continuously monitored or updated based on the measured voltage. When the determined distance between a distal end of a torch head, or distal end of a consumable at the torch head, and a workpiece is above a predetermined or desired distance, the actuator extends the torch head. The actuator extends the torch head until the determined distance meets the desired distance or reaches a fully extended state. When the determined distance between a distal end of a torch head, or distal end of a consumable at the torch head, and a workpiece is below a desired distance, the actuator retracts the torch head. The actuator retracts the torch head until the determined distance meets the desired distance.

Additionally or alternatively, the rate at which the torch head may be displaced may be proportional to the rate at which the measured voltage varies from the criteria. For example, the larger the measured voltage varies from the criteria, e.g., predetermined or threshold voltage, the greater the speed at which the actuator extends or retracts the torch head. For example, as the difference between the measured voltage and criteria increases, the speed increases. And the smaller difference between the measured voltage and the criteria, the lower the speed at which the actuator extends or retracts the torch head. For example, as the difference between the measured voltage and criteria decreases, the speed decreases. That is, the acceleration of the torch head may be based on the difference between the measured voltage and the criteria.

Additionally or alternatively, the rate at which the torch head may be displaced may be proportional to the rate at which the determined gap G distance between the distal end of torch head (or consumable) and the workpiece varies from the predetermined or desired distance. For example, the larger the determined gap distance G varies from the desired distance, e.g., predetermined distance, the greater the speed at which the actuator extends or retracts the torch head. For example, as the difference between the determined distance and desired distance increases, the torch head's speed increases. And the smaller difference between the determined distance and the desired distance, the lower the speed at which the actuator extends or retracts the torch head. For example, as the difference between the determined distance and desired distance decreases, the torch head's speed decreases. That is, the acceleration of the torch head may be determined by the difference between the determined distance and the desired distance.

In some implementations the method 400 may include repeating operations 402-406 during a processing operation. The processing operation may be a plasma cutting operation or welding operation. During a plasma cutting operation, the arc may flow from an electrode disposed at a distal end of the torch head to the workpiece. During a welding operation, the arc may travel from a filler material (e.g., weld wire, weld strip, or other filler material capable of forming a weld) or an electrode, to the workpiece. The determined distance may be indicative of a distance between the electrode and/or filler material to the workpiece.

In some implementations, the method may further include adjusting a feed speed of a filler material based on the measured voltage and/or determined distance. For example, during a welding operation, a filler material (e.g., a weld wire) may be fed by a wire feeder through the torch head of the handheld torch. The wire feeder may adjust the speed of at which the wire is fed to the torch head based on the measured voltage and/or determined distance. The wire feeder may be further configured to receive an indication of an amount the actuator will adjust the torch head. The wire feeder may further adjust the feed speed based on the indication.

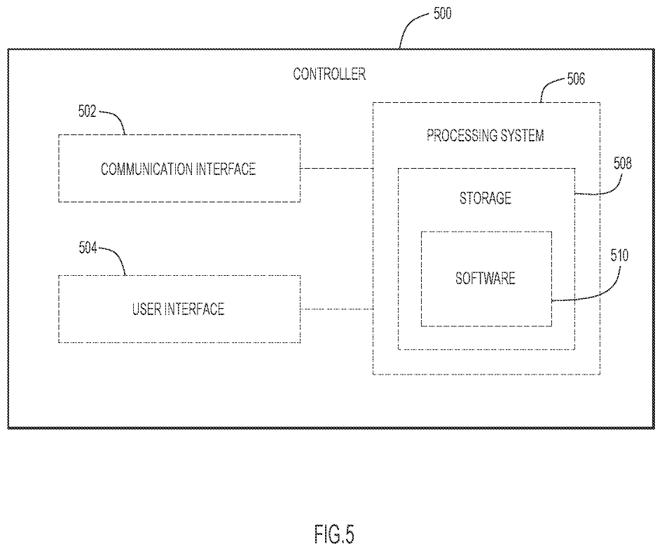

FIG. 5 depicts an embodiment of a controller 500 for determining a distance between a distal end of a torch head of a handheld torch and a workpiece comprising a communication interface 502, user interface 504, and processing system 506 in communication with communication interface 502 and user interface 504. Processing system 506 includes storage 508, which can comprise a disk drive, flash drive, memory circuitry, or other memory device. Storage 508 can store software 510 which is used in the operation of the processor 500.

Storage 508 may include a disk drive, flash drive, data storage circuitry, or some other memory apparatus. For example, storage 508 may include a buffer. Software 510 may include computer programs, firmware, or some other form of machine readable instructions, including an operating system, utilities, drivers, network interfaces, applications, or some other type of software. Processing system 506 may include a microprocessor, processor, and/or other circuitry to retrieve and execute software 510 from storage 508. Controller 500 may further include other components such as a power management unit, a control interface unit, etc., which are omitted for clarity. Communication interface 502 permits controller 500 to communicate with other processing operation elements. For example, the processing operation elements may include a processing operation power supply, a handheld torch, an actuator of the handheld torch, a wire feeder, and/or a sensor (disposed in the power supply, handheld torch, and/or wire feeder). User interface 504 permits the configuration and control of the operation of controller 500. The controller 500 may be disposed in the handheld torch, wire feeder, and/or the processing operation power supply.

The example systems and methods described herein can be performed under the control of a processing system executing computer-readable codes embodied on a computer readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

While the invention has been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

It is also to be understood that the handheld torch described herein, or portions thereof may be fabricated from any suitable material or combination of materials, such as plastic, foamed plastic, wood, cardboard, pressed paper, metal, supple natural or synthetic materials including, but not limited to, cotton, elastomers, polyester, plastic, rubber, derivatives thereof, and combinations thereof. Suitable plastics may include high-density polyethylene (HDPE), low-density polyethylene (LDPE), polystyrene, acrylonitrile butadiene styrene (ABS), polycarbonate, polyethylene terephthalate (PET), polypropylene, ethylene-vinyl acetate (EVA), or the like. Suitable foamed plastics may include expanded or extruded polystyrene, expanded or extruded polypropylene, EVA foam, derivatives thereof, and combinations thereof.

Finally, it is intended that the present application covers modifications and variations come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Similarly, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”.

What is claimed is:

1. A system for controlling a handheld torch comprising:
a torch comprising a handle and a torch head disposed at the handle;
a power supply comprising a processor, the power supply configured to:
provide power to the torch to initiate a processing operation;
determine an arc voltage between the torch head and a workpiece during the processing operation; and
determine a distance between the torch head the workpiece based on the determined arc voltage.

2. The system of claim 1, further comprising an actuator operatively coupled to the torch head and the handle, the actuator configured to move the torch head relative to the handle.

3. The system of claim 2, wherein the power supply is further configured to transmit a control signal to the actuator, the control signal being based on the determined distance between the torch head and the workpiece.

4. The system of claim 3, wherein the actuator moves the torch head relative to the handle based on the control signal.

5. The system of claim 3, wherein the power supply is further configured to vary the control signal to maintain a predetermined distance between the torch head and the workpiece.

6. The system of claim 3, wherein the power supply is further configured to stop transmitting the control signal in response to the arc voltage meeting a predetermined voltage.

7. A method for determining a distance between a torch head of a handheld torch and a workpiece comprising:
measuring, by a processor at a power supply, an arc voltage of an arc between the torch head and the workpiece; and
determining, by the processor, a distance between the torch head and the workpiece based on the arc voltage.

8. The method of claim 7, wherein the determining further comprises comparing the arc voltage to a criteria.

9. The method of claim 8, wherein the criteria is a predetermined arc voltage.

10. The method of claim 8, further comprising:
in response to the arc voltage varying from the criteria, causing an actuator in the handheld torch to adjust the distance between the torch head and the workpiece, wherein the distance is adjusted proportionally to an amount the arc voltage varies from the criteria.

11. The method of claim 7, further comprising:
causing an adjustment of the torch head relative to a handle of the handheld torch based on the measured arc voltage.

12. The method of claim 11, wherein the adjustment maintains a predetermined distance between the torch head and the workpiece.

13. The method of claim 11, wherein the adjustment of the torch head comprises activating an actuator.

14. The method of claim 13, wherein the actuator comprises one of, or any combination of, a coil actuator, electric drive motor, pneumatic drive motor, or shape-memory alloy actuator.

15. A handheld torch comprising:
a torch comprising a handle that extends from a proximal end to a distal end;
a torch head disposed at the distal end of the handle; and
an actuator operatively coupled to the torch head and the handle, the actuator configured to move the torch head relative to the handle.

16. The handheld torch of claim 15, wherein the actuator is further configured to move the torch head relative to the handle based on an arc voltage.

17. The handheld torch of claim 15, wherein the actuator is further configured to receive a control signal from a power supply, and the actuator moves the torch head relative to the handle based on the control signal.

18. The handheld torch of claim 17, wherein the control signal is based on an arc voltage.

19. The handheld torch of claim 17, wherein the control signal varies based on a variance of an arc voltage.

20. The handheld torch of claim 15, wherein the actuator is further configured to maintain a distance between the torch head and a workpiece.
